(19) United States
(12) Patent Application Publication
(10) Pub. No.: US 2009/0171501 A1
(43) Pub. Date: Jul. 2, 2009

(54) SYSTEMS AND METHOD FOR MAINTAINING A GAP BETWEEN SUCCESSIVE OBJECTS

(76) Inventor: Steven L. Hills, San Jose, CA (US)

Correspondence Address: PATRICK W. RASCHE (22697);ARMSTRONG TEASDALE LLP, ONE METROPOLITAN SQUARE, SUITE 2600, ST. LOUIS, MO, 63102-2740, US

(21) Appl. No.: 11/964,520

(22) Filed: Dec. 26, 2007

(51) Int. Cl. B65G 47/22; B65G 43/00; G01B 21/16

(52) U.S. Cl. 700/230; 198/617; 702/150

(57) ABSTRACT

Systems and method are provided for controlling a gap between objects to be scanned by security scanning systems. In one aspect, a method is provided for maintaining a predetermined gap between successive objects to be scanned by a security scanning machine. The method includes measuring an initial gap defined between a trailing edge of a first object and a leading edge of a second object and, based on a comparison between the initial gap and the predetermined gap, controlling a speed of a first conveyor relative to a speed of a second conveyor operatively coupled to the first conveyor such that the predetermined gap between the first object and the second object is maintained.

### FIELD OF THE INVENTION

The field of the invention relates generally to baggage inspection systems and, more particularly, to baggage inspection systems including dynamic gap control, and a method of facilitating the same.

### BACKGROUND OF THE INVENTION

Since the events of Sep. 11, 2001, the Department of Homeland Security has increased security dramatically in U.S. airports. Such security efforts include scanning passengers and carry-on bags and luggage for contraband including explosive materials.

A security scanning machine that continuously processes bags and/or containers requires a minimum gap between bags. If the gap between bags is too small, then the data acquired by the security scanning machine from one bag may be commingled with data acquired from another bag. Such commingling of data may compromise the evaluation of the bags. If the gap between bags is too large, then the throughput of the security scanning machine may be too low.

At least some known baggage handling systems process bags by staging the bags individually on conveyors such that each conveyor of a series of interconnected conveyors holds only a single bag. Moreover, at least some known baggage handling systems process bags using a windowing, which involves creating a predetermined distance between a leading edge of each bag. However, neither individually staging the bags nor windowing offers sufficient control over bags with varying sizes and shapes.

Further, at least some known baggage handling systems control the window size between bags by adjusting the window size relative to the size of either the first bag or the proceeding second bag. Such a control method may result in an inconsistent performance due to the varying dimensions of the bags positioned on the conveyors. There is a need for a system that is able to perform dynamic gap control by setting the speed of the conveyors according to a desired gap between successive bags.

### BRIEF DESCRIPTION OF THE INVENTION

In one aspect, a method is provided for maintaining a predetermined gap between successive objects to be scanned by a security scanning machine. The method includes measuring an initial gap defined between a trailing edge of a first object and a leading edge of a second object and, based on a comparison between the initial gap and the predetermined gap, controlling a speed of a first conveyor relative to a speed of a second conveyor operatively coupled to the first conveyor such that the predetermined gap between the first object and the second object is maintained.

In another aspect, a system for maintaining a predetermined gap between successive objects to be scanned by a security scanning machine is provided. The system includes a plurality of sensors configured to sense a position of a trailing edge of the first object and a position of a leading edge of the second object, such that an initial gap is defined by a distance between the first object trailing edge and the second object leading edge. The system also includes a plurality of encoders, each encoder configured to generate a pulse signal for each unit of distance traveled by a respective conveyor, and a processor coupled in signal communication to the sensor and the plurality of encoders. The processor is configured to control a speed of a first conveyor relative to a speed of a second conveyor such that the predetermined gap between the first object trailing edge and the second object leading edge is maintained.

In a further aspect, a baggage handling system for maintaining a predetermined gap between successive objects to be scanned by a security scanning machine is provided. The baggage handling system includes a plurality of conveyors operatively coupled to enable a first object and a second object to travel towards the security scanning machine, the plurality of conveyors including a first conveyor and a second conveyor. The system also includes a sensor configured to sense a position of a trailing edge of a first object, generate a first signal representative of the first object trailing edge position, sense a position of a leading edge of a second object, and generate a second signal representative of the second object leading edge position. The baggage handling system also includes a plurality of encoders, each encoder configured to generate a pulse signal for each unit of distance traveled by a respective conveyor, and a processor coupled in signal communication to the sensor and the plurality of encoders. The processor is configured to receive the first and second signals from the sensor, receive the pulse signal from each encoder, and control a speed of the first conveyor relative to a speed of the second conveyor to facilitate maintaining the predetermined gap.

### BRIEF DESCRIPTION OF THE DRAWINGS

FIGS. 1-5 show exemplary embodiments of the systems and methods described herein.

FIG. 1 is a schematic diagram of a baggage handling system.

FIG. 2 is an exploded view of the baggage handling system shown in FIG. 1.

FIG. 3 is a speed profile illustrating tiered speed control used by the baggage handling system shown in FIG. 1.

FIG. 4 is another speed profile illustrating tiered speed control used by the baggage handling system shown in FIG. 1.

FIG. 5 is a schematic diagram of a system architecture that may be used with the baggage handling system shown in FIG. 1.

FIG. 6 is a flowchart illustrating a method of operation of the baggage handling system shown in FIG. 1.

### DETAILED DESCRIPTION OF THE INVENTION

The embodiments described herein provide systems and a method for dynamically controlling a gap between successive bags to be scanned by a security scanning machine, such as a continuous-flow scanning machine. In one embodiment, a series of sensors sense a position of the leading edge and a position of the trailing edge of successive bags. An initial gap is determined based on the difference between the trailing edge of the first bag and the leading edge of the second bag, and is also based on a distance traveled by a conveyor between time of the trailing and leading edge positions. The initial gap is compared to a predetermined gap and, based on the comparison, the speeds of the individual conveyors are adjusted to obtain and/or maintain the predetermined gap. Moreover, the embodiments described herein provide technical effects such as, but not limited to, sensing bag edge positions using multiple sensors, generating a signal representative of the positions, processing the signal, and controlling conveyors to obtain and/or maintain a predetermined gap between the bags. As used herein, a predetermined gap is a selected distance that is desired between successive bags as the bags enter the security scanning machine. In some embodiments, the predetermined gap is adjustable such that an operator enters a value

Various embodiments of the invention are described below in reference to the application in connection with and operation of a system for inspecting containers for contraband. Such containers may include passenger carry-on luggage, checked luggage, cargo crates, pallets, and/or other containers. However, it should be apparent to those skilled in the art and guided by the teachings herein provided that these various embodiments of the invention are likewise applicable to any suitable system for scanning containers including, without limitation, boxes and drums. As such, as used herein, the term “object” may refer to a bag, suitcase, cargo crate, pallet, or any container that is moved by a series of conveyors towards a scanning system. Moreover, the various embodiments of the invention are likewise applicable to any system for scanning objects that are transported by water, land, and/or air.

Moreover, although embodiments of the invention are described below in reference to application in connection with and operation of a system incorporating a security scanning system for inspecting containers, it should be apparent to those skilled in the art and guided by the teachings herein provided that any suitable gap control system may be used in alternative embodiments.

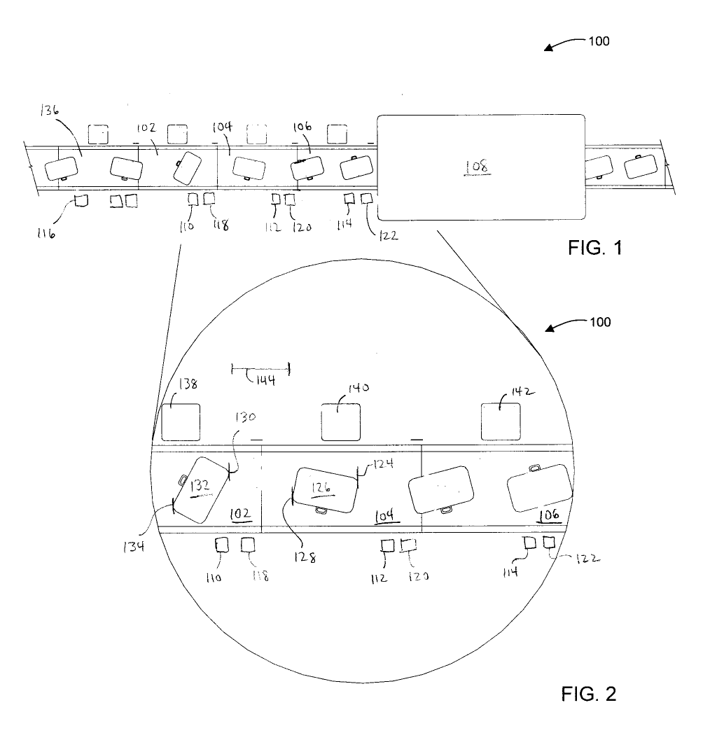

FIG. 1 is a schematic diagram of a baggage handling system 100. FIG. 2 is a magnification of a section of system 100. In the exemplary embodiment, system 100 includes a plurality of conveyors, such as first conveyor 102, second conveyor 104, and third conveyor 106. Each conveyor 102, 104, and/or 106 is operatively coupled to an adjacent conveyor 102, 104, and/or 106 to enable multiple successive objects, such as baggage, to travel towards a security scanning machine 108. System 100 also includes a plurality of sensors, such as first sensor 110, second sensor 112, third sensor 114, and fourth sensor 116. System 110 also includes a plurality of corresponding encoders, such as first encoder 118, second encoder 120, and third encoder 122.

Sensors 110, 112, 114, and 116 sense a position of a leading edge 124 of a first object 126, and a position of a trailing edge 128 of first object 126. In addition, sensors 110, 112, and 114 sense a position of a leading edge 130 of a second object 132, and a position of a trailing edge 134 of second object 132. In the exemplary embodiment, sensors 110, 112, 114, and 116 are infrared (IR) sensors. Moreover, in the exemplary embodiment, sensor 116 is a vertical sensor array, or light curtain, and sensors 110, 112, and 114 are point sensors. Sensor 116 includes a plurality of IR transmitters and an opposing plurality of IR receivers, and is oriented in a first plane, such as a vertical plane, or an approximately vertical plane. The first plane is perpendicular to a plane defined by a top surface 136 of each conveyor 102, 104, and 106. Sensor 116 senses the positions of leadings edges 122 and 128, and the positions of trailing edges 126 and 132 as each object 126 and 132 enters system 100. Sensors 110, 112, and 114 project an IR beam that is oriented in a second plane perpendicular to the first plane. As such, the second plane is a horizontal plane, or an approximately horizontal plane, that is approximately parallel to top surface 136. Each IR beam is oriented between approximately 5.0 centimeters (cm) and approximately 10.0 cm above top surface 136. Sensors 110, 112, and 114 each project an IR beam across top surface 136 such that, when an object, such as object 126, breaks an IR beam, thereby preventing the IR beam from being received by a receiver positioned opposite a projecting sensor 110, 112, and/or 114, the object is registered by sensor 110, 112, and/or 114 as having crossed a particular marker point. In an alternative embodiment, each sensor 110, 112, 114, and 116 is configured as a light curtain and senses the positions of leading edges 124 and 130, and the positions of trailing edges 128 and 134, in the first plane but not the second plane. In another alternative embodiment, each sensor 110, 112, 114, and 116 is configured as a point sensor and senses the positions of leading edges 124 and 130, and the positions of trailing edges 128 and 134, in the second plane but not the first plane. Further alternative embodiments may use various ratio of the number of sensors 110, 112, 114, and/or 116 configured to sense the positions of leading edges 124 and 130 and the positions of trailing edges 128 and 134 in the first plane and the number of sensors 110, 112, 114, and/or 116 configured to sense in the second plane.

Encoders 118, 120, and 122 detect a distance traveled by a respective conveyor 102, 104, and 106. For example, encoder 118 detects when conveyor 102 has traveled approximately 1.0 centimeter (cm). Encoder 118 generates one or more pulse signals for each centimeter conveyor 102 travels.

In the exemplary embodiment, system 100 also includes a plurality of variable frequency drives, such as first drive 138, second drive 140, and third drive 142. Each variable frequency drive 138, 140, and 142 is operatively coupled to a respective conveyor 102, 104, and 106 to control the speed of the respective conveyor 102, 104, and 106 relative to adjacent conveyors 102, 104, and/or 106. Moreover, system 100 includes a processor (not shown in FIG. 1) that is communicatively coupled to sensors 110, 112, 114, and 116, encoders 118, 120, and 122, and variable frequency drives 138, 140, and 142. The processor receives the signal representative of the positions recorded by sensors 110, 112, 114, and 116, and the pulse signals generated by encoders 118, 120, and 122, and determines an initial gap between first object 126 and second object 132. The initial gap is defined as a distance between trailing edge 128 of first object 126 and leading edge 130 of second object 132. The processor compares the initial gap to a predetermined gap, which is a selected distance that is desired between successive objects as the objects enter security scanning machine 108. In the exemplary embodiment, the predetermined gap is between approximately 30.0 centimeters (cm) and approximately 20.0 cm or, more specifically, the predetermined gap is approximately 25.0 cm. Based on the comparison, the processor controls the speed of conveyors 102, 104, and/or 106 using respective variable frequency drives 138, 140, and/or 142. More specifically, the processor controls the speed of first conveyor 102 relative to second conveyor 104 while second object 132 is in a first transition zone 144. A transition zone is an area, or zone, in which an object has nearly left one conveyor to be transferred to an adjacent conveyor. While second object 132 is in first transition zone 144, and if the initial gap is approximately equal to the predetermined gap, the processor utilizes a first variable frequency drive 138 to set the speed of first conveyor 102 approximately equal to the speed of second conveyor 104, which is driven by a second variable frequency drive 140. The initial gap and the predetermined gap are considered by the processor to be approximately equal when the initial gap is within approximately 5.0 cm of the predetermined gap. Alternatively, while second object 132 is in first transition zone 144, and if the initial gap is greater than the predetermined gap, the processor utilizes first variable frequency drive 138 to increase the speed of first conveyor 102 relative to second conveyor 104. Conversely, while second object 132 is in first transition zone 144, and if the initial gap is less than the predetermined gap, the processor utilizes first variable frequency drive 138 to decrease the speed of first conveyor 102 relative to second conveyor 104.

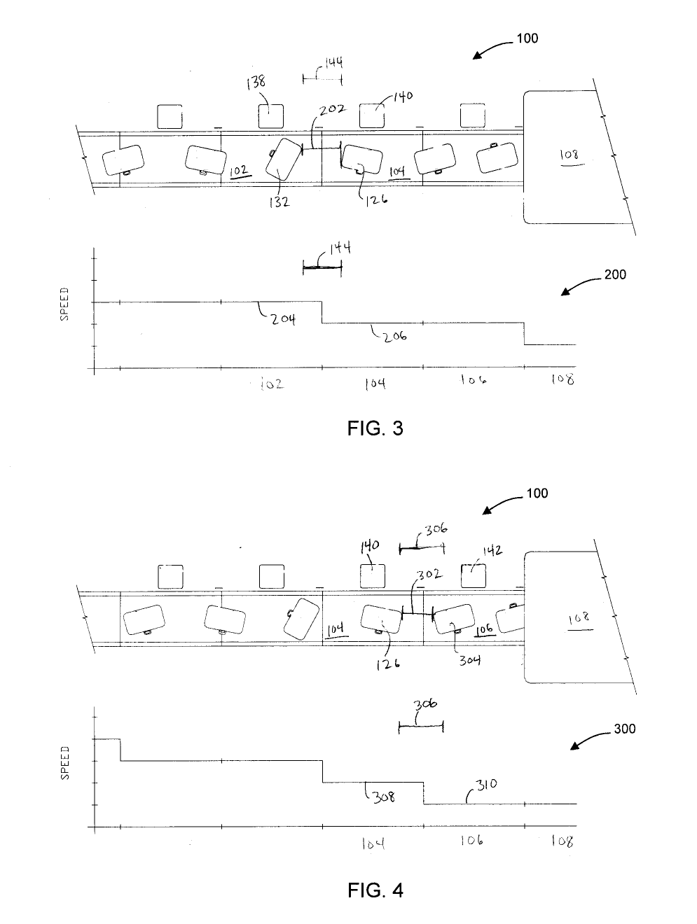

In order to maintain stability, and to prevent objects 126 and 132 from tipping, the processor uses a tiered speed control between adjacent conveyors 102, 104, and/or 106 when adjusting the speed of conveyors 102, 104, and 106. FIGS. 3 and 4 are speed profiles 200 and 300 illustrating tiered speed control used by system 100. The tiered speed control prevents a conveyor, such as first conveyor 102, from moving at more than a maximum set speed faster or slower than an adjacent conveyor, such as second conveyor 104. FIGS. 3 and 4 show that the speeds of individual conveyors, such as first conveyor 102 and second conveyor 104, are controlled by the processor in relation to each other in order to maintain stability of first and second objects 126 and 132 and also to maintain the predetermined gap as first and second objects 126 and 132 travel towards security scanning machine 108.

FIG. 3 shows an initial gap 202 within first transition zone 144 that is greater than the predetermined gap. As such, the processor (not shown in FIG. 3) utilizes first variable frequency drive 138 to enable first conveyor 102 to have a greater speed 204 than a speed 206 of second conveyor 104. Alternatively, the processor may utilize second variable frequency drive 140 to slow second conveyor 104 such that second conveyor 104 has a speed 206 less than the speed 204 of first conveyor 102. Similarly, FIG. 4 shows an initial gap 302 defined between first object 126 and a third object 304. Initial gap 302 is greater than the predetermined gap within a second transition zone 306. As such, the processor (not shown in FIG. 4) utilizes second variable frequency drive 140 to enable second conveyor 104 to have a greater speed 308 than a speed 310 of third conveyor 106. Alternatively, the processor may utilize third variable frequency drive 142 to slow third conveyor 106 such that third conveyor 106 has a speed 310 less than the speed 308 of second conveyor 104.

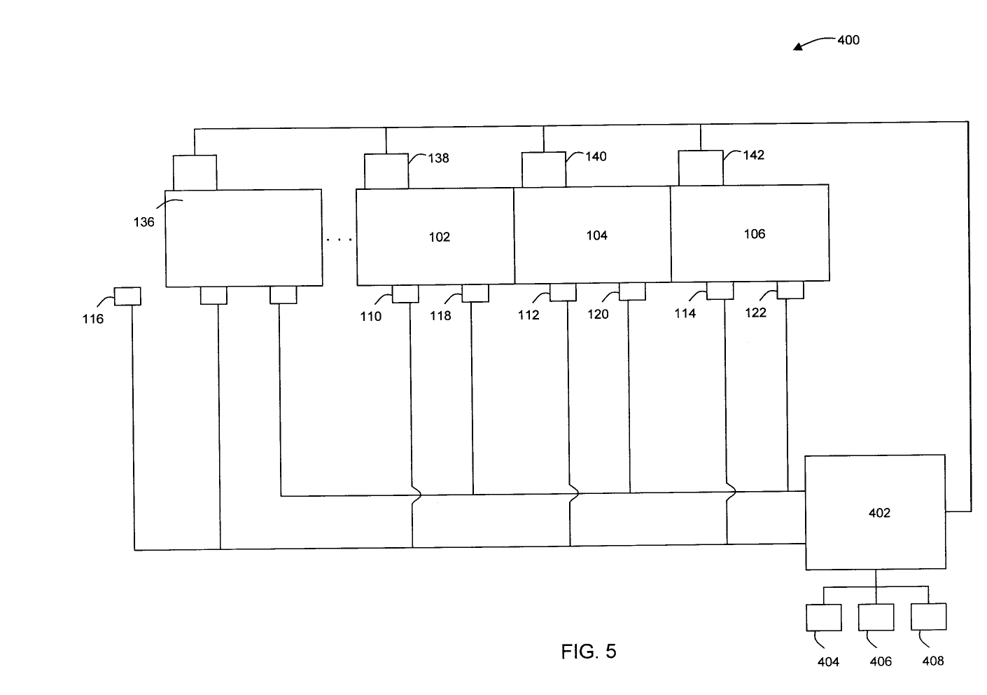

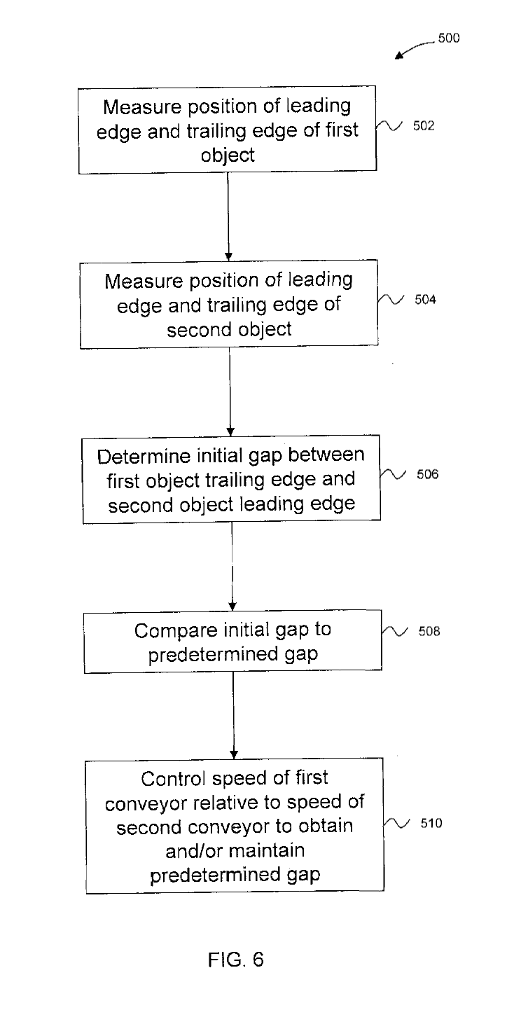

FIG. 5 is a schematic diagram of a system architecture 400 that may be used with baggage handling system 100 (shown in FIGS. 1 and 2). In the exemplary embodiment, system 400 includes a plurality of sensors, such as sensors 110, 112, 114, and 116. As described above, sensors 110, 112, 114, and 116 sense leading edge position 124 and trailing edge position 128 of first object 126 (each shown in FIGS. 1 and 2), and leading edge position 130 and trailing edge position 134 of second object 132 (each shown in FIGS. 1 and 2). In the exemplary embodiment, sensor 116 is oriented to sense in a first plane, such as a vertical plane or an approximately vertical plane. Sensors 110, 112, and 114 are oriented to sense in a second plane perpendicular to the first plane, such as a horizontal plane or an approximately horizontal plane. The first, or vertical, plane is approximately perpendicular to a plane defined by top surface 136 of each conveyor 102, 104, and 106. The second, or horizontal, plane is approximately parallel to top surface 136. In an alternative embodiment, each sensor 110, 112, 114, and 116 is configured as a light curtain and senses the positions of leading edges 124 and 130, and the positions of trailing edges 128 and 134, in the first plane but not the second plane. In another alternative embodiment, each sensor 110, 112, 114, and 116 is configured as a point sensor and senses the positions of leading edges 124 and 130, and the positions of trailing edges 128 and 134, in the second plane but not the first plane. Further alternative embodiments may use various ratio of the number of sensors 110, 112, 114, and/or 116 configured to sense the positions of leading edges 124 and 130 and the positions of trailing edges 128 and 134 in the first plane and the number of sensors 110, 112, 114, and/or 116 configured to sense in the second plane.

In the exemplary embodiment, system 400 also includes a plurality of encoders, such as encoders 118, 120, and 122, that are coupled to respective conveyors 102, 104, and 106. Encoders 118, 120, and 122 detect a distance traveled by respective conveyors 102, 104, and 106 and generate pulse signals representative of the distances for processing.

System 400 also includes a processor 402. Processor 402 may include any programmable system including systems using microcontrollers, reduced instruction set circuits (RISC), application specific integrated circuits (ASICs), programmable logic circuits (PLCs), and any other circuit or processor capable of executing the functions described herein. The above examples are exemplary only and are thus not intended to limit in any way the definition and/or meaning of the term processor. Processor 402 is coupled in signal communication to sensors 110, 112, 114, and 116, encoders 118, 120, and 122, and variable frequency drives 138, 140, and 142. Processor 402 receives the signal generated by sensors 110, 112, 114, and 116, and the pulse signals generated by encoders 118, 120, and 122, and determines an initial gap between first object 126 and second object 132. For example, when first object trailing edge 128 (shown in FIG. 1) breaks IR beam being monitored by sensor 110, sensor 110 generates a signal representative of the position of first object trailing edge 128 and transmits the signal to processor 402. Similarly, when second object leading edge 130 breaks the same beam, sensor 110 generates a signal representative of the position of second object leading edge 130 and transmits the signal to processor 402. During such time, encoder 118 transmits pulse signals to processor 402 for each unit traveled by conveyor 102. In the exemplary embodiment, encoder 118 generates a pulse signal for each 1.0 cm traveled by conveyor 102. Processor 402 determines the initial gap, defined as the distance between first object trailing edge 128 and second object leading edge 130. More specifically, processor 402 determines the number of units traveled by conveyor 102, using the pulse signals received from encoder 118, between the marked time point where first object trailing edge 128 passes sensor 110 and the marked time point where second object leading edge 132 passes sensor 110.

In the exemplary embodiment, processor 402 then compares the initial gap to a predetermined gap. Based on the comparison, processor 402 controls the speed of conveyors 102, 104, and 106 using respective variable frequency drives 138, 140, and 142. More specifically, processor 402 controls the speed of first conveyor 102 relative to the speed of second conveyor 104 while second object 132 is in a transition zone, such as first transition zone 144 (shown in FIGS. 1 and 2). Processor 402 includes one or more input/output (I/O) devices, such as a keyboard 404, a mouse 406, and a display 408. In the exemplary embodiment, the predetermined gap is between approximately 30.0 centimeters (cm) and approximately 20.0 cm or, more specifically, the predetermined gap is approximately 25.0 cm. In one embodiment, the predetermined gap is input into processor 402 using the I/O devices, such as keyboard 404.

FIG. 5 is a flowchart illustrating a method 500 for closing a distance between objects, such as baggage, to a predetermined gap and to then maintain the predetermined gap as the objects are loaded into a security scanning machine 108 (shown in FIG. 1), such as a continuous-flow baggage scanning machine. In the exemplary embodiment, a sensor, such as second sensor 112 (shown in FIGS. 1 and 2) senses 502 the positions of leading edge 124 and trailing edge 128 of first object 126 (shown in FIGS. 1 and 2). Second sensor 112 also senses 504 the positions of leading edge 130 and trailing edge 134 of second object 132 (all shown in FIG. 1). Second sensor 112 communicates the positions to a processor 402 (shown in FIG. 4). More specifically, when first object trailing edge 128 breaks, or interrupts, an IR beam being monitored by second sensor 112, second sensor 112 generates a signal representative of the position of first object trailing edge 128 and transmits the signal to processor 402. Similarly, when second object leading edge 130 breaks, or interrupts, the same IR beam, second sensor 112 generates a signal representative of the position of second object leading edge 130 and transmits the signal to processor 402. Second encoder 120 (shown in FIGS. 1 and 2) detects a distance traveled by second conveyor 104 (shown in FIGS. 1 and 2) and generates pulse signals representative of the distances for processing. More specifically, second encoder 120 transmits pulse signals to processor 402 for each unit traveled by conveyor 104. In the exemplary embodiment, second encoder 120 generates a pulse signal for each 1.0 cm traveled by conveyor 104.

In the exemplary embodiment, processor 402 receives the sensor signals from second sensor 112 and the pulse signals from second encoder 120, and determines 506 an initial gap between first object trailing edge 128 and second object leading edge 130. More specifically, processor 402 determines the number of units traveled by second conveyor 104, using the pulse signals received from second encoder 120, between the marked time point where first object trailing edge 128 passed second sensor 112 and the marked time point where second object leading edge 130 passed second sensor 112. Processor 402 then compares 508 the initial gap to the predetermined gap. Based on the comparison, processor 402 controls 510 the speed of first conveyor 102 and second conveyor 104 using respective variable frequency drives 138 and 140 (shown in FIGS. 1 and 2). Specifically, when the initial gap is approximately equal to the predetermined gap, processor 402 sets the speed of first conveyor 102 approximately equal to the speed of second conveyor 104. When the initial gap is greater than the predetermined gap, processor 402 increases the speed of first conveyor 102 relative to the speed of second conveyor 104, enabling the initial gap to be closed until the predetermined gap is obtained. Processor 402 then sets the speed of first conveyor 102 approximately equal to the speed of second conveyor 104 to maintain the predetermined gap. When the initial gap is less than the predetermined gap, processor 402 decreases the speed of first conveyor 102 relative to the speed of second conveyor 104, enabling the initial gap to increase until the predetermined gap is obtained. Processor 402 then sets the speed of first conveyor 102 approximately equal to the speed of second conveyor 104 to maintain the predetermined gap.

In summary, in one embodiment, a system is provided for maintaining a predetermined gap between successive objects, such as bags, to be scanned by a security scanning machine. In the exemplary embodiment, the system includes a plurality of sensors configured to sense a position of a trailing edge of the first object and to sense a position of a leading edge of the second object. In one embodiment, at least one sensor is oriented in a first plane, such as a vertical plane or a substantially vertical plane. In an alternative embodiment, at least one sensor is oriented in a second plane perpendicular to the first plane, such as a horizontal plane or a substantially horizontal plane.

In the exemplary embodiment, the system also includes a plurality of encoders configured to generate a pulse signal for each unit of distance traveled by a respective conveyor. Moreover, in the exemplary embodiment, the system includes a processor. The processor is coupled in signal communication to the plurality of sensors and the plurality of encoders. The processor controls a speed of the first conveyor relative to a speed of the second conveyor such that the predetermined gap between the first object trailing edge and the second object leading edge is maintained. The processor also determines an initial gap between the trailing edge of the first object and the leading edge of the second object.

In one embodiment, the system includes a plurality of encoders coupled to the conveyors and to the processor. Each encoder generates a pulse signal for each unit traveled by a respective conveyor, and transmits the pulse signal to the processor. In one embodiment, the system also includes a plurality of variable frequency drives operatively coupled to the conveyors, such that each variable drive controls a speed of a respective conveyor. The variable frequency drives are coupled in signal communication to the processor, enabling the processor to control the speed of a first conveyor by controlling a first variable frequency drive and to control the speed of a second conveyor by controlling a second variable frequency drive.

When the processor determines that the initial gap is approximately equal to the predetermined gap, the processor sets the speed of the first conveyor approximately equal to the speed of the second conveyor. When the processor determines that the initial gap is greater than the predetermined gap, the processor increases the speed of the first conveyor relative to the speed of the second conveyor. Further, when the processor determines that the initial gap is less than the predetermined gap, the processor decreases the speed of the first conveyor relative to the speed of the second conveyor.

While various embodiments of the invention have been described, those skilled in the art will recognize that modifications of these various embodiments of the invention can be practiced within the spirit and scope of the claims.

What is claimed is:

1. A method for maintaining a predetermined gap between successive objects to be scanned by a security scanning machine, said method comprising:
measuring an initial gap defined between a trailing edge of a first object and a leading edge of a second object; and
based on a comparison between the initial gap and the predetermined gap, controlling a speed of a first conveyor relative to a speed of a second conveyor operatively coupled to the first conveyor such that the predetermined gap between the first object and the second object is maintained.

2. A method in accordance with claim 1, wherein measuring an initial gap comprises:
sensing a position of the trailing edge of the first object and a position of the leading edge of the second object;
sensing a distance traveled by the second conveyor between the first object trailing edge and the second object leading edge position; and
determining the initial gap based on the first object trailing edge position, the second object leading edge position, and the number of units traveled by the second conveyor between the first object trailing edge position and the second object leading edge position, the initial gap one of maintained, increased, and decreased to maintain the predetermined gap.

3. A method in accordance with claim 2, wherein sensing a position of the trailing edge of the first object and a position of the leading edge of the second object comprises sensing the first object trailing edge position and the second object leading edge position using at least one sensor, the at least one sensor oriented to monitor at least one of a first plane and a second plane that is substantially perpendicular to the first plane.

4. A method in accordance with claim 2, wherein sensing a position of the trailing edge of the first object and a position of the leading edge of the second object comprises:
sensing a first interruption in a beam being monitored by a sensor, the first interruption caused by the trailing edge of the first object;
sensing a second interruption in the beam being monitored by the sensor, the second interruption caused by the leading edge of the second object;
generating a first signal representative of the first interruption; and
generating a second signal representative of the second interruption.

5. A method in accordance with claim 4, wherein controlling a speed of a first conveyor relative to a speed of a second conveyor comprises:
receiving, by the processor, the first signal representative of the first interruption caused by the leading edge of the first object;
receiving, by the processor, the second signal representative of the second interruption caused by the leading edge of the first object;
receiving, by the processor, a plurality of pulse signals representative the distance traveled by the second conveyor between the first object trailing edge and the second object leading edge position;
processing the first signal, the second signal, and the plurality of pulse signals; and
controlling at least one of the speed of the first conveyor and the second conveyor using a plurality of variable frequency drives.

6. A method in accordance with claim 1, wherein upon a transition of the first object and the second object from the first conveyor to the second conveyor the initial gap is approximately equal to the predetermined gap, controlling the speed of the first conveyor relative to the speed of the second conveyor comprises setting the speed of the first conveyor approximately equal to the speed of the second conveyor.

7. A method in accordance with claim 1, wherein upon a transition of the first object and the second object from the first conveyor to the second conveyor the initial gap is greater than the predetermined gap, controlling the speed of the first conveyor relative to the speed of the second conveyor comprises increasing the speed of the first conveyor relative to the speed of the second conveyor.

8. A method in accordance with claim 1, wherein upon a transition of the first object and the second object from the first conveyor to the second conveyor the initial gap is less than the predetermined gap, controlling the speed of the first conveyor relative to the speed of the second conveyor comprises decreasing the speed of the first conveyor relative to the speed of the second conveyor.

9. A method in accordance with claim 1, wherein controlling a speed of a first conveyor relative to a speed of a second conveyor comprises controlling a speed of a first conveyor relative to a speed of a second conveyor in a baggage handling system.

10. A system for maintaining a predetermined gap between successive objects to be scanned by a security scanning machine, said system comprising:
a plurality of sensors configured to sense a position of a trailing edge of the first object and a position of a leading edge of the second object, an initial gap is defined by a distance between the first object trailing edge and the second object leading edge;
a plurality of encoders, each encoder of the plurality of encoders configured to generate a pulse signal for each unit of distance traveled by a respective conveyor of a plurality of conveyors; and
a processor coupled in signal communication to said plurality of sensors and said plurality of encoders, said processor configured to control a speed of said first conveyor relative to a speed of said second conveyor such that the predetermined gap between the first object trailing edge and the second object leading edge is maintained.

11. A system in accordance with claim 10, wherein a first sensor of said plurality of sensors is oriented in a first plane and a second sensor of said plurality of sensors is oriented in a second plane substantially perpendicular to the first plane.

12. A system in accordance with claim 10, wherein said system is a baggage handling system.

13. A system in accordance with claim 10, further comprising a plurality of variable frequency drives operatively coupled to said plurality of conveyors, each variable frequency drive of said plurality of variable frequency drives configured to control a speed of a respective conveyor of said plurality of conveyors.

14. A system in accordance with claim 13, wherein said plurality of variable frequency drives are coupled in signal communication to said processor, said processor further configured to:
control the speed of said first conveyor by controlling a first variable frequency drive of said plurality of variable frequency drives; and
control the speed of said second conveyor by controlling a second variable frequency drive of said plurality of variable frequency drives.

15. A system in accordance with claim 13, wherein upon transition of the first object and the second object from said first conveyor to said second conveyor, said processor is further configured to one of:
set the speed of said first conveyor approximately equal to the speed of said second conveyor if the initial gap is approximately equal to the predetermined gap;
increase the speed of said first conveyor relative to the speed of said second conveyor if the initial gap is greater than the predetermined gap; and
decrease the speed of said first conveyor relative to the speed of said second conveyor if the initial gap is less than the predetermined gap.

16. A baggage handling system for maintaining a predetermined gap between successive objects to be scanned by a security scanning machine, said baggage handling system comprising:
a plurality of conveyors operatively coupled to enable a first object and a second object to travel towards the security scanning machine, said plurality of conveyors comprising a first conveyor and a second conveyor;
a sensor configured to:
sense a position of a trailing edge of the first object;
generate a first signal representative of the first object trailing edge position;
sense a position of a leading edge of the second object; and
generate a second signal representative of the second object leading edge position;
a plurality of encoders, each encoder of said plurality of encoders configured to generate a pulse signal for each unit of distance traveled by a respective conveyor of said plurality of conveyors; and
a processor coupled in signal communication to said sensor and said plurality of encoders, said processor configured to:
receive the first and second signals from said sensor;
receive the pulse signal from each said encoder; and
control a speed of said first conveyor relative to a speed of said second conveyor to facilitate maintaining the predetermined gap.

17. A baggage handling system in accordance with claim 16, wherein said sensor comprises a plurality of sensors, a first sensor of said plurality of sensors is oriented in a first plane and a second sensor of said plurality of sensors is oriented in a second plane substantially perpendicular to the first plane.

18. A baggage handling system in accordance with claim 16, further comprising a plurality of variable frequency drives, a first variable frequency drive of said plurality of variable frequency drives is operatively coupled to said first conveyor and a second variable frequency drive of said plurality of variable frequency drives is operatively coupled to said second conveyor.

19. A baggage handling system in accordance with claim 18, wherein said plurality of variable frequency drives are communicatively coupled to said processor, said processor further configured to:
control the speed of said first conveyor by controlling said first variable frequency drive; and
control the speed of said second conveyor by controlling said second variable frequency drive.

20. A baggage handling system in accordance with claim 18, wherein upon transition of the first object and the second object from said first conveyor to said second conveyor, said processor is further configured to one of:
set the speed of said first conveyor approximately equal to the speed of said second conveyor if the initial gap is approximately equal to the predetermined gap;
increase the speed of said first conveyor relative to the speed of said second conveyor if the initial gap is greater than the predetermined gap; and
decrease the speed of said first conveyor relative to the speed of said second conveyor if the initial gap is less than the predetermined gap.
